(19) United States
(12) Patent Application Publication
(10) Pub. No.: US 2026/0354391 A1
(43) Pub. Date: Nov. 12, 2026

(54) SERPENTINE CONVEYOR-BASED DOUGH PROOFING SYSTEM AND METHOD FOR CONTINUOUS BAKING PROCESSES

(71) Applicant: Gary Gottenbusch, Cincinnati, OH (US)

(72) Inventor: Gary Gottenbusch, Cincinnati, OH (US)

(21) Appl. No.: 19/731,266

(22) Filed: Jul. 6, 2026

Related U.S. Application Data
(63) Continuation of application No. 19/200,807, filed on May 7, 2025, now Pat. No. 12,690,598.

(51) Int. Cl. A21C 13/02

(52) U.S. Cl. CPC A21C 13/02

(57) ABSTRACT

A compact serpentine conveyor-based dough proofing system and method for continuous baking processes is disclosed. The system comprises a vertically stacked array of alternating-direction conveyors that guide dough in a serpentine path, enabling extended proofing travel within a compact linear footprint. The dough enters at the top conveyor and sequentially drops through a series of conveyors below, each reversing direction to maximize space efficiency. The system includes an enclosed housing with zoned environmental control, providing warmer, humid conditions at upper levels and cooler, drier conditions at lower levels, optimizing fermentation and dough surface properties. The method allows for continuous dough proofing with precise control over time, temperature, and humidity, accommodating various dough forms such as extruded, braided, or cut strips. The optional features include post-proofing stiffening via refrigeration and pre-or post-proofing caustic treatment. The present invention improves throughput, energy efficiency, and product quality in continuous baking lines.

### CROSS-REFERENCE TO RELATED APPLICATIONS

This application is a continuation of U.S. Nonprovisional Patent Application No. Ser. No. 19/200,807, entitled “SERPENTINE CONVEYOR-BASED DOUGH PROOFING SYSTEM AND METHOD FOR CONTINUOUS BAKING PROCESSES,” filed on May 7, 2025, the entire contents of which are hereby incorporated by reference in their entirety.

### 1. TECHNICAL FIELD

The present disclosure generally relates to continuous baking systems, specifically to a compact, multi-level serpentine proofing conveyor apparatus for proofing dough products using controlled heat and humidity in a space-saving configuration prior to baking.

### 2. BACKGROUND/DESCRIPTION OF THE RELATED ART

Conventional dough proofing systems in continuous baking lines are typically long and linear, often requiring up to 400 feet of space to provide sufficient dwell time for dough development. This extensive footprint poses challenges for space optimization in industrial bakeries and limits the flexibility of production line layouts. Additionally, such systems expose a large surface area to ambient conditions, making it difficult to maintain consistent heat and humidity throughout the proofing chamber. This can result in uneven proofing, affecting dough rise, texture, and final baked quality.

Furthermore, existing systems do not efficiently utilize natural heat and humidity dynamics, leading to energy inefficiencies and inconsistent product characteristics. It is also difficult to integrate specific environmental gradients, such as warmer, more humid conditions early in the proofing cycle and cooler, drier conditions later, to optimize dough surface appearance and structure. In systems that involve pre-proofing treatments such as caustic baths, there is limited provision for post-treatment cooling or stiffening, which is often necessary for certain product types like pretzels.

Therefore, there is a need for a more compact, energy-efficient, and controllable proofing system and method that maintains product quality while reducing spatial and operational inefficiencies.

### BRIEF SUMMARY

In one aspect, the present disclosure provides a serpentine conveyor system for proofing dough in a continuous baking process. The system comprises a plurality of conveyor belts arranged in vertically spaced, alternating directional layers, wherein a continuous dough ribbon is conveyed in a first direction along a first upper conveyor, then transferred downward onto a second conveyor conveying in a reverse direction, and further transferred downward in alternating forward and reverse directions through subsequent conveyors. The system enables extended proofing length within a minimized linear footprint, maintains a controlled heat and humidity gradient from top to bottom for optimized dough conditioning, and optionally includes a cooling segment post-caustic treatment for dough stiffening.

The system further includes a plurality of conveyors arranged in a vertically stacked and alternating configuration, each conveyor positioned to convey dough in a horizontal direction opposite to the direction of the conveyor immediately above or below it. The system further includes a dough input system configured to deliver a continuous dough stream or discrete dough portions onto a topmost conveyor. The system further includes a plurality of drop zones disposed between adjacent conveyors to allow the dough to descend sequentially from one conveyor to the next in a serpentine path. The system further includes an enclosed housing surrounding the stacked conveyors, the housing comprising one or more environmental control zones configured to regulate temperature and humidity at different vertical levels.

The system further includes at least one controller operatively connected to the conveyors and environmental control zones, configured to control conveyor speed and environmental conditions based on a desired proofing profile. Further, the plurality of conveyors comprises at least ten conveyors, each having a length of approximately 40 feet, thereby enabling a total proofing path of approximately 400 feet within a linear footprint of about 10 feet. The environmental control zones include steam injectors, air movers, and temperature and humidity sensors for creating a thermal and humidity gradient from the topmost conveyor to the bottommost conveyor. The topmost conveyors are configured to operate in a warmer and more humid environment than the bottommost conveyors, to promote initial fermentation and surface conditioning of the dough.

The system further comprises a programmable logic controller (PLC) configured to adjust conveyor speeds and environmental parameters in real-time based on dough type or product recipe. Each conveyor is made of food-grade material and is removably mounted to facilitate cleaning and maintenance. The system further comprises an optional refrigeration section downstream of the proofing system for cooling or stiffening the dough prior to baking or slicing. The drop zones include angled chutes or curved guides to minimize mechanical stress on the dough during vertical transfer between conveyors.

In another aspect, the present disclosure provides a serpentine conveyor method for proofing dough in a continuous baking process. The method comprises the step of: receiving a continuous ribbon or portioned dough at a first conveyor positioned at a top level of a vertically stacked conveyor system; conveying the dough horizontally along the first conveyor in a first direction; allowing the dough to drop from the first conveyor to a second conveyor below via a drop zone; conveying the dough along the second conveyor in a second, opposite horizontal direction; repeating the drop and alternate-direction conveying steps through a plurality of stacked conveyors, thereby moving the dough along a serpentine path; enclosing the stacked conveyors within a housing configured to maintain zoned environmental control, including heat and humidity regulation at different vertical levels, and proofing the dough as it travels through the serpentine path, with conditions at upper levels being warmer and more humid and lower levels being cooler and drier; and exiting the dough from a bottom conveyor for subsequent baking or processing steps.

The method further comprises the step of, passing the dough through a caustic bath either before entering or after exiting the proofing system. The method further comprises the step of, cooling or stiffening the dough with a refrigeration system after proofing, prior to baking or cutting. The proofing environment is further controlled using steam injection and humidity modulation to maintain zoned environmental conditions across the vertical stack. The proofing system is enclosed in an insulated housing to retain thermal and humidity energy and improve consistency.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates a compact serpentine conveyor-based dough proofing system for continuous baking processes, according to one or more embodiments, and

FIG. 2 illustrates a flowchart of a compact serpentine conveyor-based dough proofing method for continuous baking processes, according to an embodiment of the present invention.

### DETAILED DESCRIPTION

The present invention relates to a compact, high-efficiency dough proofing system designed for integration into continuous baking processes. This compact serpentine conveyor-based dough proofing system addresses the need for extended proofing times within confined floor spaces, typical in industrial baking operations. It uses a vertically stacked, serpentine path of conveyor belts enclosed in a zoned, controlled environment to proof a variety of dough forms with consistency, energy efficiency, and process flexibility.

This present invention discloses a serpentine proofing conveyor designed for use in continuous dough baking systems. It incorporates the full range of standard processing steps, from dough mixing to final baking, with a specific focus on the proofing section of the line. The system is compatible with various dough formats, including braids, extruded dough, and strip cuts, making the description generally applicable across methods. Further, depending on the process, the dough cutting may occur before or after the caustic bath. The system utilizes stacked, offset conveyors to create a serpentine path. According to the present invention, the dough travels in a continuous ribbon format as it moves forward on the top conveyor, then drops down to a second conveyor that moves in the opposite direction, and continues in this zigzag fashion through successive layers. Each drop allows the dough to be conveyed in alternating directions. A typical setup may include 3, 4, 5, 6, 7, 8, 9, 10 or more levels, enabling up to 400 feet of proofing path within a compact 10-foot linear footprint.

The key benefits of the present invention are, space efficiency, improved thermal efficiency and optimized proofing conditions. The serpentine configuration maximizes the proofing path within minimal linear space. For instance, 10 conveyor levels at 40 feet each deliver a 400-foot proofing length. Concentrating heat and humidity in a compact volume reduces exposure to ambient conditions, ensuring more consistent and energy-efficient proofing. The natural rise of heat and steam within the vertical stack creates a gradient: warmer, more humid conditions at the upper levels and cooler, drier conditions at the lower levels. This thermal profile enhances dough development and results in a shinier finish post-bake. An optional refrigeration system may be integrated immediately after the caustic wash to cool and stiffen the dough, enhancing handling and downstream performance.

In the present invention, the food items are formed from dough. The dough used in the present invention can be any type of edible dough, including, for example, laminated or non-laminated dough, dough with some sweeteners added, doughs that are leavened, doughs that have been fermented, doughs with flavorings and/or doughs with inclusions or toppings.

The dough useful in the present invention includes those selected from the group consisting of: multi-grain; rice-based; corn-based; rye-based; soda style; wheat-based; butter dough; flavored dough; whole grain-based; cornmeal-based; gluten-free; graham-based; and flatbread style.

The dough useful in the present invention is made according to methods generally known in the art, and includes mixing flour, fat and moisture (ordinarily water) and most often, salt. Optional ingredients, such as flavors, inclusions, colors, nutritional supplements, leavening agents, emulsifiers, etc. may be added as well. The dough may then be sheeted, rolled, or formed according to skill in the art.

The flour component in dough useful in the present invention may be any edible flour, including hard wheat flour, soft wheat flour, corn flour, multi-grain flour, rye flour, rice flour, barley flour, graham flour, whole wheat flour, high amylose flour, low amylose flour, and the like. Different grain constituents lend different texture, taste, and appearance to a baked good. Flours useful herein are of a conventional type and quality including cake flour, bread flour, and all-purpose flour. Wheat flours are preferred but other flours conventionally used in the preparation of baked goods are also employed in full or partial substitution for the wheat flour. One protein range for wheat flour used in the present invention is between about 7 to 15% by weight of the flour. A general all-purpose flour is also usable. This type of all-purpose flour generally comprises a mixture of both hard and soft wheat flours, i.e., both high protein level and low protein level flours. Such flours are useful if the average protein content ranges from about 7 to 15% by weight.

In one or more embodiments, the flour has average protein content range of at most 7, 7, 9, 10, 11, 12, 13, 14, 15% by weight. While chlorinated flours are used herein, unchlorinated flours are also usable because chlorination is an expensive, though unnecessary flour processing step. Unmalted flours may be used provided the flours are derived from wheats with minimal sprout damage. Enzyme inactivated flours are also usable. Flour having low polyphenol oxidase activity, flour having a flour enrichment with all reduced iron, a binder of metal ions, an organic acid, and the like are also usable in the present invention.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not for some other embodiments.

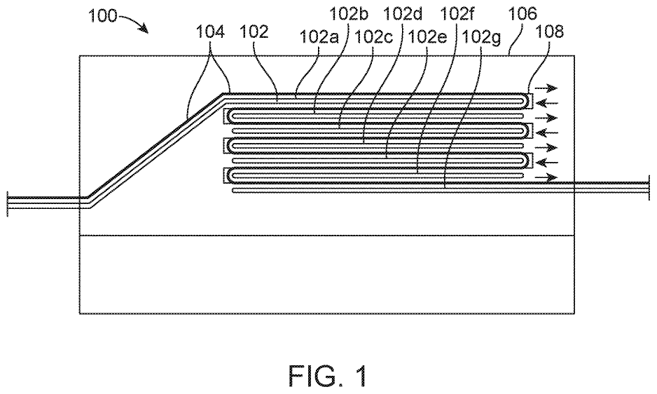

FIG. 1 illustrates a compact serpentine conveyor-based dough proofing system 100 for continuous baking processes, according to one or more embodiments. The compact serpentine conveyor-based dough proofing system 100 comprises a series of ten or more food-grade conveyors 102 mounted in an alternating, stacked configuration. Each conveyor 102 moves the dough 104 horizontally, either forward or in the reverse direction, depending on its position in the stack. The ingredients to make the dough comprising flour and water are placed in a mixer to form and knead the dough. The dough is then placed onto a conveyor, to form the dough into a continuous sheet. Typically a belt of the conveyor is dusted with flour, the dough is added to the belt and the dough is then dusted with flour and rolled into a sheet.

The dough 104 moves along the top conveyor 102a in one direction, then drops to the next conveyor 102b below, which conveys in the opposite direction, and continues this alternating serpentine movement through subsequent conveyors 102c, 102d, 102e, 102f, 102g, and so on, until it exits at the bottom conveyor 102z or the final conveyor in the series. This design enables a long effective proofing distance (for example, 400 feet of travel) within a small linear footprint (for example, 10 feet of factory floor space), significantly reducing the spatial requirements compared to traditional linear proofers.

To maintain consistent fermentation and surface conditioning, the entire conveyor stack (102a, 102c, 102d, and so on) is enclosed within a thermally insulated housing 106. This enclosure supports zoned environmental control, including heat and humidity management. Each zone, typically divided into top, middle, and bottom segments, can be independently managed using steam injectors, air movers, and temperature sensors. The natural rise of heat and moisture is utilized advantageously: the upper levels of the system 100 maintain a warmer and more humid environment suitable for early-stage proofing, while the lower levels progressively transition to a cooler, drier climate. This thermal gradient naturally enhances dough structure 104 and improves surface finish, especially important for products where shine and texture are critical after baking.

In one embodiment, the conveyor belts of the conveyors 102 are powered by synchronized motors, allowing fine-tuned speed control to regulate proofing time. Transfer between each level of the system 100 is facilitated by passive drop zones 108 or curved guide chutes, enabling the dough to gently descend from one level to the next without damaging the structure or alignment. The system 100 can handle a variety of dough types, including, but not limited to, extruded ropes, braided products, strip-cut dough, and other shaped formats. According to the present invention, the system 100 is compatible with both pre-and post-caustic bath stages means it can be integrated seamlessly into the production of pretzels, bagels, and similar specialty baked goods.

A critical aspect of the invention is the method 200 followed for processing dough 104. This method 200 begins with the dough 104 exiting a mixing, extruding, or shaping station and entering the top-level conveyor 102a of the proofing system 100. The dough 104 then moves along this top conveyor 102a through a warm, humid zone ideal for activating yeast and enabling early fermentation. At the end of this belt, it drops vertically onto the next conveyor 102b below. This second conveyor 102b moves the dough 104 in the opposite direction, continuing proofing under slightly less warm and humid conditions. This process repeats, alternating directions and descending level by level through the stacked system 100. Each conveyor layer (102a, 102c, 102d, and so on) introduces dough 104 to a new microclimate, where environmental conditions gradually shift from warm and moist to dry and slightly cooler, improving dough consistency and surface finish as proofing progresses.

According to an embodiment of the present invention, the optional enhancement includes a caustic bath and cooling module, particularly useful for pretzel or bagel production. In such configurations, the dough 104 may pass through a caustic wash either before or after the proofing process. Further, depending on the process, the dough cutting may occur before or after the caustic bath. Following this, an optional refrigeration segment may be used to stiffen the dough 104, ensuring better handling, slicing, or shine prior to baking. This stiffening step may be performed using chilled air systems or refrigerated conveyors 102 adjacent to the proofing system 100.

This serpentine proofing method 200 offers a host of operational advantages. First and foremost, it significantly reduces the floor space required for long-duration proofing, allowing bakeries to increase capacity without expanding their physical footprint. Additionally, the enclosed and zoned design improves energy efficiency by limiting heat and humidity loss and concentrating environmental control only where needed. The built-in thermal gradient created by the vertical structure supports more efficient proofing and improves product finish. It also supports a higher level of automation and process repeatability.

The compact serpentine conveyor-based dough proofing system 100 and method 200 may include integrated monitoring sensors for temperature, humidity, and airflow. These sensors can feed data into a programmable logic controller (PLC) or recipe management system, allowing operators to automate belt speeds and environmental parameters based on product type or batch requirements. The compact serpentine conveyor-based dough proofing system 100 is modular and scalable, additional conveyors can be added to increase total proofing time, or multiple units can be run in parallel to increase throughput. Sanitation and maintenance are facilitated by thoughtful design features. The insulated enclosure includes access panels for cleaning, and each conveyor section is built to be removable or easily accessible for sanitation. Drainage systems direct condensation or washdown water to appropriate outlets, and food-safe materials ensure hygiene standards are maintained throughout.

According to this present invention, the compact serpentine conveyor-based dough proofing system 100 delivers a high-capacity, compact, and energy-efficient dough proofing solution suitable for modern continuous baking lines. The serpentine conveyor layout combined with zoned environmental control allows for long-duration proofing within a small footprint. Its adaptability to different dough types and upstream/downstream processing steps ensures that it can be easily integrated into a wide variety of bakery operations. The method and apparatus together represent a major improvement in both the productivity and quality achievable in continuous dough processing systems.

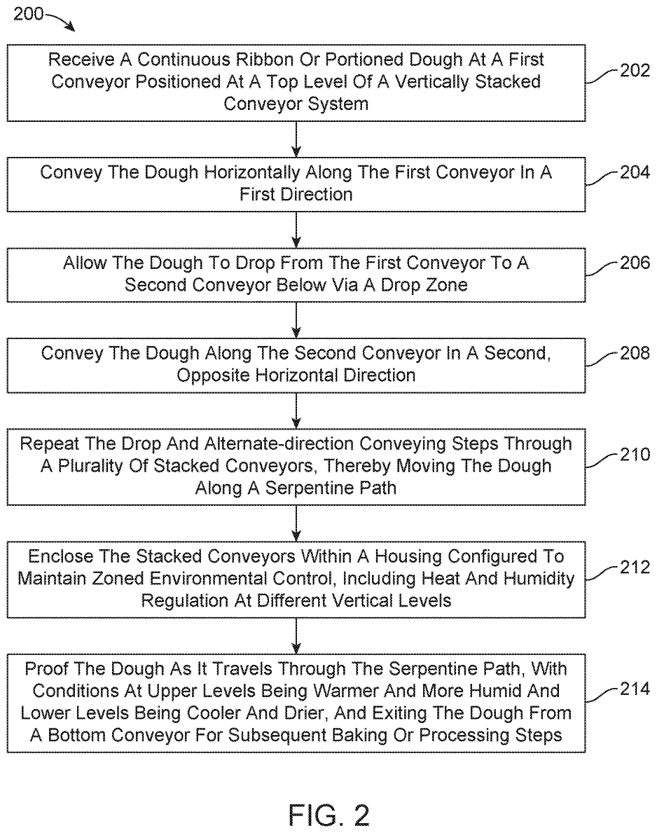

FIG. 2 illustrates a flowchart of a compact serpentine conveyor-based dough proofing method 200 for continuous baking processes, according to an embodiment of the present invention. At step 202, the method 200 for proofing dough 104 in a continuous baking process using a compact serpentine conveyor system 100 comprises the steps of, receiving a continuous ribbon or portioned dough 104 at a first conveyor 102a positioned at a top level of a vertically stacked conveyor system 100. At step 204, the dough 104 is conveyed horizontally along the first conveyor 102a in a first direction. At step 206, the dough 104 is allowed to drop from the first conveyor 102a to a second conveyor 102b below via a drop zone 108. At step 208, the dough 104 is conveyed along the second conveyor 102 b in a second, opposite horizontal direction. At step 210, the drop and alternate-direction conveying steps are repeated through a plurality of stacked conveyors 102, thereby moving the dough 104 along a serpentine path. At step 212, the stacked conveyors 102 are enclosed within a housing 106 configured to maintain zoned environmental control, including heat and humidity regulation at different vertical levels. The proofing environment or system 100 is controlled using steam injection and humidity modulation to maintain zoned environmental conditions across the vertical stack conveyors 102. The proofing system 100 is enclosed in an insulated housing 106 to retain thermal and humidity energy and improve consistency. At step 214, proofing the dough 104 as it travels through the serpentine path, with conditions at upper levels being warmer and more humid and lower levels being cooler and drier; and exiting the dough 104 from a bottom conveyor for subsequent baking or processing steps.

In one embodiment, the multi belt proofer is a series of continuous belts arranged in tiers, over which the sheet of dough passes while the sheet of dough proofs in the proofing room. It has a tier selection capability for adjusting the resting period of an incoming sheet of dough into the proofing room. In one embodiment, the multi belt proofer also comprises a self-aligning belt mechanism to keep the tiered belts perfectly aligned to one another. Alignment of the belts ensures the centerline of the sheet of dough remains consistent throughout the transfer of the sheet of dough through the proofing room.

In one embodiment, the multi belt proofer is located in a room having specific conditions such as a controlled humidity, preferably between 60% to 90% relative humidity, preferably 60% to 80%, more preferably 60% to 75% and typically 70% relative humidity, and relative temperature of between 30 °C and 40 °C. In another embodiment, the multi belt proofer is located in a room having controlled humidity of at least 50, 55, 60, 65, 70% or more relative humidity. In another embodiment, the multi belt proofer is located in a room having controlled temperature of at least 30, 31, 32, 33, 34, 35, 36, 37, 38, 39, 40 °C or more. However, it can be appreciated that the leavening requirements will vary depending on the composition of the dough and the above is provided as an example only. The conditions of the proofing room can also vary depending on the ambient or climatic conditions outside the proofing room. For example if the dough is relatively colder than expected when entering the proofing room, the conditions of the proofing room are adjusted to suit. The humidity and warmth of the proofing room also enables the dough to proof, yeast to act and gluten to relax. After proofing, typically for 10 to 40 minutes, the dough is ready to be cut and baked. In one embodiment, the dough is ready to leave the proofing room can be when it has risen by at least 50% to 100%. In one embodiment, the dough has risen at least 50, 55, 60, 65, 70, 75, 80, 85, 90, 95, 100% or more. The rise depends on the makeup of the flour used to make the dough. It can be appreciated that the proofing times may also vary depending on the specific ingredients in the dough, the activity of the yeast, the ambient process conditions outside the proofing room, and the proofing room conditions.

In various embodiments, the dough 104 may remain in a continuous ribbon or be portioned into discrete segments at any point before, during, or after serpentine proofing. Such segmentation, whether performed upstream, midstream, or downstream of the proofing system 100, remains within the scope of the present invention and does not depart from the continuous nature of the proofing process or method 200 as claimed. The system 100 accommodates and is operable with continuous or semi-continuous streams, including dough lengths segmented for handling, transfer, or post-proofing treatments.

In an alternative embodiments, a second proofer, like the first proofer discussed above and illustrated in FIG. 2, is used and comprises a series of conveyor belts arranged so that the elongated dough strips remain substantially continuous and are never transversely cut as they follow a serpentine track through the proofer. Once proofed, the sheet of dough, which can be considered a continuous sheet of dough, is cut into portions, typically by circular slitting blades and transverse cutters, however alternative cutting methods can be used.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure is not limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A dough proofing system comprising:
a housing;
a plurality of conveyors positioned within the housing in vertically spaced tiers, the plurality of conveyors including a first conveyor, a second conveyor vertically below the first conveyor, and at least one additional conveyor vertically below the second conveyor;
wherein the conveyors are arranged such that each conveyor conveys dough in a horizontal direction opposite a horizontal conveying direction of a vertically adjacent conveyor;
a dough inlet configured to deliver dough to the first conveyor;
a plurality of transfer regions respectively positioned between vertically adjacent conveyors, each transfer region configured to transfer the dough from an upstream conveyor to a downstream conveyor; and
a drive system configured to move the dough sequentially along the conveyors and through the transfer regions in a serpentine proofing path within the housing.

2. The dough proofing system of claim 1, wherein the dough inlet is configured to receive a continuous ribbon of dough.

3. The dough proofing system of claim 1, wherein the dough inlet is configured to receive discrete dough portions.

4. The dough proofing system of claim 1, wherein at least one of the transfer regions is configured to transfer the dough downward by gravity from the upstream conveyor to the downstream conveyor.

5. The dough proofing system of claim 1, wherein at least one of the transfer regions includes an angled chute, a curved guide chute, or a combination thereof configured to reduce stretching, folding, tearing, misalignment, or mechanical stress of the dough during transfer.

6. The dough proofing system of claim 1, wherein the drive system comprises synchronized motors configured to coordinate conveyor speeds across the vertically spaced tiers.

7. The dough proofing system of claim 6, further comprising a controller configured to adjust a speed of one or more conveyors to establish a selected residence time of the dough within the housing.

8. The dough proofing system of claim 1, further comprising a self-aligning belt mechanism configured to maintain a lateral alignment or centerline of the dough during transfer between the vertically spaced tiers.

9. The dough proofing system of claim 1, wherein the plurality of conveyors comprises at least ten conveyors, each having a length of about 40 feet, thereby providing about 400 feet of proofing travel within a linear footprint of about 10 feet.

10. The dough proofing system of claim 1, further comprising at least one additional dough proofing system arranged in parallel with the dough proofing system to increase throughput.

11. A dough processing line comprising:
a first dough proofer comprising a first plurality of vertically stacked conveyors arranged to advance a continuous dough ribbon along a first serpentine proofing path;
a cutting station downstream of the first dough proofer and configured to cut the continuous dough ribbon into a plurality of dough portions after proofing in the first dough proofer; and
a second proofing system downstream of the cutting station and configured to receive and proof the dough portions.

12. The dough processing line of claim 11, wherein the first dough proofer comprises a housing surrounding the first plurality of vertically stacked conveyors.

13. The dough processing line of claim 11, wherein the cutting station comprises one or more circular slitting blades, transverse cutters, or other cutting mechanisms.

14. The dough processing line of claim 11, further comprising a caustic treatment station positioned upstream of the first dough proofer or downstream of the first dough proofer.

15. The dough processing line of claim 11, further comprising a refrigeration section configured to cool or stiffen dough before baking, slicing, transfer, or further handling.

16. A method of proofing dough, comprising:
receiving dough at an upper conveyor of a proofing system having a plurality of vertically stacked conveyors;
advancing the dough along a serpentine path by conveying the dough in alternating horizontal directions along the vertically stacked conveyors and sequentially transferring the dough between vertically adjacent conveyors;
controlling a speed of one or more conveyors to establish a selected residence time of the dough within the proofing system; and
maintaining temperature and humidity conditions within the proofing system while the dough traverses the serpentine path.

17. The method of claim 16, wherein receiving the dough comprises receiving a continuous ribbon of dough, and further comprising maintaining the continuous ribbon substantially continuous while advancing the continuous ribbon along the serpentine path.

18. The method of claim 16, further comprising selecting a number of conveyor tiers through which the dough travels to establish the selected residence time.

19. The method of claim 16, wherein maintaining the temperature and humidity conditions comprises maintaining relative humidity between about 50% and about 90% and maintaining a temperature between about 30 °C and about 40 °C

20. The method of claim 16, further comprising cutting the dough after the dough exits the proofing system and proofing resulting dough portions in a second proofing system downstream of the proofing system.
